(19) United States
(12) Patent Application Publication
(10) Pub. No.: US 2021/0027546 A1
(43) Pub. Date: Jan. 28, 2021

(54) TECHNIQUES FOR LABELING CUBOIDS IN POINT CLOUD DATA

(71) Applicant: Scale AI, Inc., San Francisco, CA (US)

(72) Inventors: Steven Hao, San Jose, CA (US); Leigh Marie BRASWELL, San Francisco, CA (US); Evan MOSS, San Francisco, CA (US)

(21) Appl. No.: 16/518,704

(22) Filed: Jul. 22, 2019

(51) Int. Cl. G06T 19/20

(52) U.S. Cl. CPC G06T 19/20; G06T 2219/004; G06T 2219/2016; G06T 2210/56; G06T 2200/24; G06T 2219/2008

(57) ABSTRACT

Techniques are disclosed for facilitating the labeling of cuboid annotations in point cloud data. User-drawn annotations of cuboids in point cloud data can be automatically adjusted to remove outlier points, add relevant points, and fit the cuboids to points representative of an object. Interpolation and object tracking techniques are also disclosed for propagating cuboids from frames designated as key frames to other frames. In addition, techniques are disclosed for, in response to user adjustment of the size of a cuboid in one frame, automatically adjusting the sizes of cuboids in other frames while anchoring a set of non-occluded faces of the cuboids. The non-occluded faces may be determined as the faces that are closest to a LIDAR (light detection and ranging) sensor in the other frames.

### BACKGROUND

### Technical Field

Embodiments of the present disclosure relate generally to data labeling and, more specifically, to techniques for labeling cuboids in point cloud data.

### Description of the Related Art

Advances in the field of machine learning and increases in available computing power have led to a proliferation in the applications of machine learning. Many machine learning models, including deep neural networks, require large amounts of labeled data to train and verify. Such labeled data typically includes samples that have been tagged with labels. For example, in the context of autonomous driving, labeled light detection and ranging (LIDAR) point cloud data in which cuboids that bound objects (e.g., vehicles) have been tagged may be used to train a machine learning model to predict such cuboids based on input LIDAR data as part of the autonomous vehicle's perception system.

Labeled data can be obtained by relying on human judgment to tag data with appropriate labels. However, such manual labeling of data is time consuming and labor intensive, and few traditional tools exist to facilitate the process of labeling data.

As the foregoing illustrates, what is needed in the art are techniques to facilitate data labeling.

### SUMMARY

One embodiment provides a computer-implemented method for facilitating the labeling of data. The method includes receiving a user-specified cuboid annotation associated with a first point cloud in a first frame. The method further includes identifying one or more points in the first point cloud representing an object included in the first frame. In addition, the method includes determining a first adjusted cuboid annotation based on a fit of the first adjusted cuboid annotation to the one or more points representing the object.

Another embodiment provides a computer-implemented method for propagating adjustments to a cuboid annotation size. The method includes receiving a user-specified adjustment to a size of a first cuboid annotation in a first frame in a plurality of frames. The method further includes identifying a second frame in the plurality of frames that includes a second cuboid annotation around an object, where a first set of faces of the object that are not occluded from view correspond to a second set of faces of the second cuboid annotation. In addition, the method includes adjusting a size of the second cuboid annotation based on the user-specified adjustment to the size of the first cuboid annotation without modifying one or more planes associated with the second set of faces.

Further embodiments include non-transitory computer-readable storage media storing instructions that, when executed by a computer system, cause the computer system to perform the methods set forth above, and computer systems programmed to carry out the methods set forth above.

One advantage of the disclosed techniques is user-drawn annotations of cuboids in point cloud data can be automatically adjusted and improved upon. Techniques disclosed herein further propagate cuboids from key frames to in-between frames in a relatively smooth manner. In addition, size adjustments to cuboids are propagated while maintaining accuracy of the cuboid annotations, by anchoring a set of non-occluded faces of objects. These technical advantages represent one or more technological improvements over prior art approaches.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments. The patent or application file contains at least one drawing executed in color. Copies of this patent or patent application publication with color drawing(s) will be provided by the Office upon request and with payment of the necessary fee.

FIG. 1 is a conceptual illustration of a system configured to implement one or more embodiments.

FIG. 2 is a flow diagram of method steps for processing data labeling requests, according to various embodiments.

FIG. 3 illustrates one of the client devices shown in FIG. 2, according to various embodiments.

FIG. 4 illustrates an example user interface displaying a point cloud, according to various embodiments.

FIG. 5 illustrates an approach for automatically adjusting a user-drawn cuboid annotation, according to various embodiments.

FIG. 6 illustrates an approach for propagating cuboid annotations across frames, according to various embodiments.

FIG. 7 is a flow diagram of method steps for automatically adjusting user-drawn cuboid annotations in key frames and propagating the cuboid annotations to in-between frames, according to various embodiments.

FIG. 8 illustrates one of the steps of the method of FIG. 7 in greater detail, according to various embodiments.

FIG. 9 illustrates another one of the steps of the method of FIG. 7 in greater detail, according to various embodiments.

FIG. 10 illustrates an approach for propagating the re-sizing of a cuboid across frames, according to various embodiments.

FIG. 11 is a flow diagram of method steps for adjusting the sizes of cuboid annotations in frames, according to various embodiments.

### DETAILED DESCRIPTION

In the following description, numerous specific details are set forth to provide a more thorough understanding of the present disclosure. However, it will be apparent to one of skilled in the art that the present disclosure may be practiced without one or more of these specific details.

### System Overview

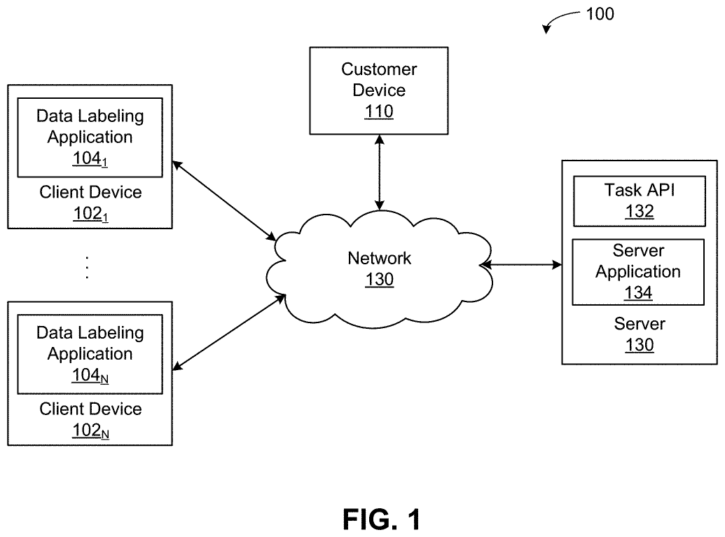

FIG. 1 is a conceptual illustration of a system 100 configured to implement one or more embodiments. As shown, the system 100 includes, without limitation, a server computing device 130 and a number of client devices 102_{1-N}, each of which is referred to individually herein as a client device 102, that interoperate to facilitate data labeling by users of the client devices 102_{1-N}, in response to a customer request. The server 130, the client devices 102_{1-N}, and a customer device 110 communicate via a network 130, which may be a wide area network (WAN) such as the Internet, a local area network (LAN), or any other suitable network. Although a single server 130 and customer device 110 are shown for illustrative purposes, the system 100 may generally include any number of servers, customer devices, and client devices, each of which may be a physical computing system or a virtual computing system running in, e.g., a data center or cloud.

Illustratively, the server 130 exposes a task application programming interface (API) 132 that allows customers to send data, and data labeling requests, via API calls. Any suitable data and labeling requests may be transmitted via such API calls to the server 130. For example, in the context of autonomous vehicles, photographic, LIDAR (light detection and ranging), and/or radar (radio detection and ranging) data captured by vehicle-mounted sensors may be uploaded from the customer device 110 to the server 130, along with a request that particular types of objects (e.g., vehicles, bicycles, pedestrians, etc.) be tagged in such data. GPS (global positioning system) data may also be uploaded and is typically included in LIDAR data.

In some embodiments, the server application 134 may require the data and data labeling requests submitted via API calls to satisfy predefined restrictions. For example, restrictions may exist on which classes (e.g., cars, pedestrians, buildings, etc.) of objects can be labeled, the format and size of the data, etc.

The server application 134 processes data received via the task API 132 and sends the processed data to data labeling applications 104_{1-N} running in the client devices 102_{1-N}, along with indications of data labeling tasks to be performed by users of the client devices 102_{1-N}, based on the customer's request. Any suitable processing of received data may be performed by the server application 134. For example, in some embodiments, the server application 134 could convert photographic, LIDAR, or radar data received in different formats to a single format that the data labeling applications 104_{1-N} can read. As another example, the server application 134 could compress the received data to a smaller size. Although the server application 134 is shown as a single application for illustrative purposes, it should be understood that functionality of the server application 134 may be performed by multiple applications or other types of software in alternative embodiments.

Each of the data labeling applications 104_{1-N}, referred to individually herein as a data labeling application 104, digests and renders data received from the server application 134 for displayed via a user interface (UI). In some embodiments, the data labeling application 104 may render one or more colored point clouds for visualizing three-dimensional (3D) data (e.g., LIDAR and/or radar data), while permitting users to navigate and view the point clouds from different perspectives. The data labeling application 104 may employ various techniques during the rendering of a point cloud. For example, in some embodiments, the data labeling application 104 may use down sampling to obtain an aggregated point cloud that includes only points conveying the most information. As another example, the data labeling application 104 could, based on a user specification, blend point cloud colorings derived from different data sources (e.g., photographic, label, and/or LIDAR intensity data). In addition to displaying rendered point clouds via a UI, the data labeling application 104 may also display photographs associated with those point clouds at the same time.

In some embodiments, the data labeling application 104 may provide tools to facilitate data labeling tasks. For example, the tools could allow a user to draw annotations in the form of cuboids, label points as belonging to particular objects, etc. using a mouse and/or keyboard. As additional examples, tools could be provided that automatically adjust the position and/or orientation of a user-designated cuboid, propagate a user-designated cuboid from a key frame to other frames, etc., thereby aiding the user in performing data labeling tasks.

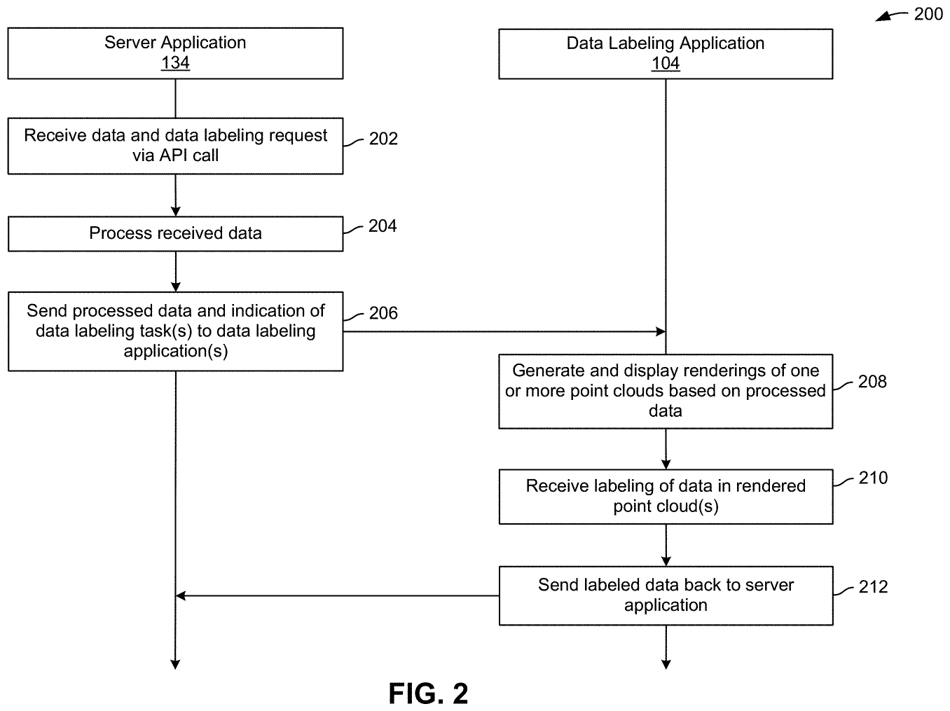

FIG. 2 is a flow diagram of method steps for processing data labeling requests, according to various embodiments. Although the method steps are described with reference to the system of FIG. 1, persons skilled in the art will understand that any system may be configured to implement the method steps, in any order, in other embodiments.

As shown, a method 200 begins at step 202, where the server application 134 receives data and a data labeling request via an API call. The data may be in any suitable format acceptable to the server application 134. For example, the server application 134 may require data to be sent in one or more JavaScript Object Notation (JSON) files. Similarly, the data labeling request may need to satisfy certain restrictions, such as which classes (e.g., vehicles, pedestrians, buildings, etc.) of objects can be labeled.

At step 204, the server application 134 processes the received data. Any suitable processing may be performed by the server application 134. As described, the processing in some embodiments may include, e.g., compressing the received data and/or converting the received data into a format that can be read by data labeling application(s). For example, the received data could be converted to a data format in which points of a 3D point cloud are represented in a list as (x, y, z) coordinates with associated time stamps.

At step 206, the server application 134 sends the processed data and an indication of data labeling task(s), based on the received request, to one or more data labeling applications. Although one data labeling application 104 is shown for illustrative purposes, it should be understood that the server application 134 may send the processed data and indication of data labeling task(s), via a network, to any number of data labeling applications running on different client devices.

At step 208, a data labeling application 104 that receives the processed data generates and displays renderings of one or more point clouds based on the received data. As described, the data labeling application 104 may display the rendered point cloud(s) via a UI that permits a user to navigate and view the point cloud(s) from different perspectives. In addition, the UI may display photographs associated with the rendered point cloud(s), and the data labeling application 104 may provide tools to facilitate labeling of the rendered point cloud(s) via the UI.

At step 210, the data labeling application 104 receives labeling of data in the rendered point cloud(s). In some embodiments, a user may navigate the point cloud(s) spatially and/or temporally and then draw annotations such as cuboids, label points as belonging to particular objects, etc. For example, the user could look around a scene, identify objects of interest, use a mouse to indicate where those objects are located, use the mouse and a keyboard to precisely size cuboids around the objects, etc. In such a case, the user may further navigate forward and/or backwards in time to see where the objects move over time, and label the objects in every frame that is associated with a distinct point in time. As described, the data labeling application 104 may provide tools that enable such labeling, as well as tools that facilitate user labeling by, e.g., automatically adjusting the position and/or orientation of a user-designated cuboid, propagating a cuboid from one frame designated as a key frame to other frames, etc.

At step 212, the data labeling application 104 sends the labeled data back to the server application 134. The labeled data may be sent to the server application 134 via a network, such as the Internet, and the server application 134 may then return the labeled data to the customer. In some embodiments, optional verification and/or other processing may be performed prior to returning labeled data to the customer.

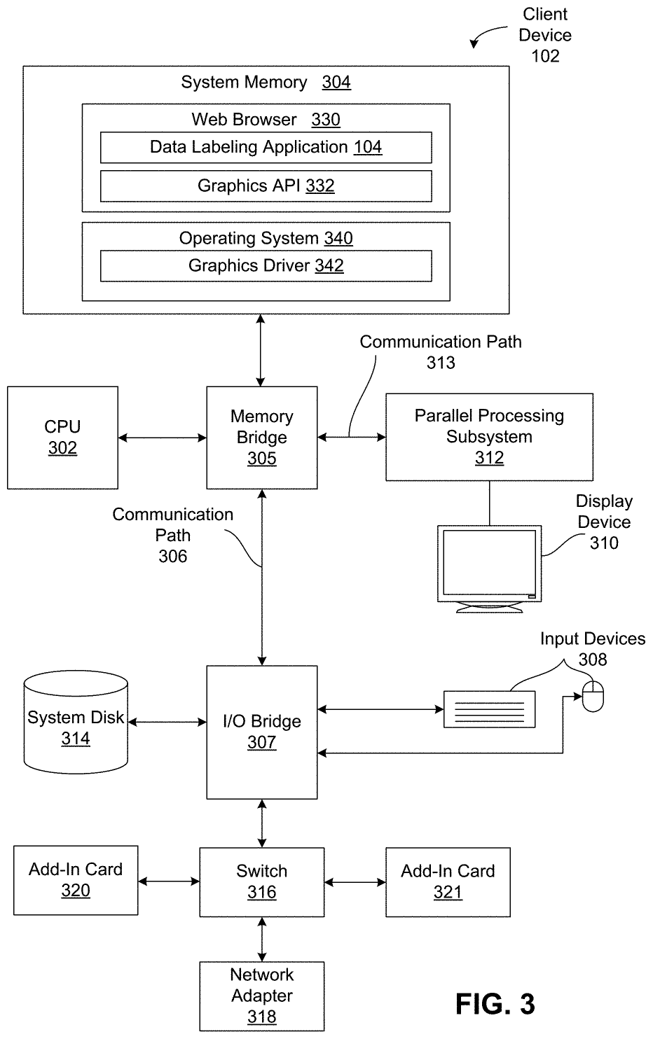

FIG. 3 illustrates one of the client devices 102_{1-N}, according to one or more embodiments. Although a client device 102 is shown for illustrative purposes, it should be understood that the server 130 and the customer device 110 may include similar physical components as the client device 102, but run different software such as the server application 134.

As shown, the client device 102 includes, without limitation, a central processing unit (CPU) 302 and a system memory 304 coupled to a parallel processing subsystem 312 via a memory bridge 305 and a communication path 313. The memory bridge 304 is further coupled to an I/O (input/output) bridge 307 via a communication path 306, and the I/O bridge 307 is, in turn, coupled to a switch 316.

In operation, the I/O bridge 307 is configured to receive user input information from input devices 308, such as a keyboard or a mouse, and forward the input information to the CPU 302 for processing via the communication path 106 and the memory bridge 305. The switch 316 is configured to provide connections between the I/O bridge 307 and other components of the computer system 300, such as a network adapter 318 and various add-in cards 320 and 321.

As also shown, the I/O bridge 307 is coupled to a system disk 314 that may be configured to store content and applications and data for use by CPU 302 and parallel processing subsystem 312. As a general matter, the system disk 314 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Finally, although not explicitly shown, other components, such as universal serial bus or other port connections, compact disc drives, digital versatile disc drives, film recording devices, and the like, may be connected to the I/O bridge 307 as well.

In various embodiments, the memory bridge 305 may be a Northbridge chip, and the I/O bridge 307 may be a Southbridge chip. In addition, communication paths 306 and 313, as well as other communication paths within the client device 102, may be implemented using any technically suitable protocols, including, without limitation, AGP (Accelerated Graphics Port), HyperTransport, or any other bus or point-to-point communication protocol known in the art.

In some embodiments, the parallel processing subsystem 312 comprises a graphics subsystem that delivers pixels to a display device 310 that may be any conventional cathode ray tube, liquid crystal display, light-emitting diode display, or the like. In such embodiments, the parallel processing subsystem 312 incorporates circuitry optimized for graphics and video processing, including, for example, video output circuitry. Such circuitry may be incorporated across one or more parallel processing units (PPUs) included within the parallel processing subsystem 312. In other embodiments, the parallel processing subsystem 312 incorporates circuitry optimized for general purpose and/or compute processing. Again, such circuitry may be incorporated across one or more PPUs included within the parallel processing subsystem 312 that are configured to perform such general purpose and/or compute operations. In yet other embodiments, the one or more PPUs included within the parallel processing subsystem 312 may be configured to perform graphics processing, general purpose processing, and compute processing operations. The system memory 104 includes at least one device driver 103 configured to manage the processing operations of the one or more PPUs within the parallel processing subsystem 312.

In various embodiments, the parallel processing subsystem 312 may be integrated with one or more of the other elements of FIG. 3 to form a single system. For example, the parallel processing subsystem 312 may be integrated with the CPU 302 and other connection circuitry on a single chip to form a system on chip (SoC).

It will be appreciated that the system shown herein is illustrative and that variations and modifications are possible. The connection topology, including the number and arrangement of bridges, the number of CPUs, and the number of parallel processing subsystems, may be modified as desired. For example, in some embodiments, the system memory 304 could be connected to CPU 302 directly rather than through memory bridge 305, and other devices would communicate with the system memory 304 via the memory bridge 305 and the CPU 302. In other alternative topologies, the parallel processing subsystem 312 may be connected to the I/O bridge 307 or directly to the CPU 302, rather than to the memory bridge 305. In still other embodiments, the I/O bridge 307 and the memory bridge 305 may be integrated into a single chip instead of existing as one or more discrete devices. Lastly, in certain embodiments, one or more components shown in FIG. 3 may not be present. For example, the switch 316 could be eliminated, and the network adapter 318 and add-in cards 320, 321 would connect directly to the I/O bridge 307.

Illustratively, the data labeling application 104 that runs in the client device 102 is a web application running in a web browser 330. Although shown as a web application for illustrative purposes, the data labeling application 104 may be implemented as a native application or other type of software in alternative embodiments. Further, functionality of the data labeling application 104 may be distributed across multiple pieces of software in some embodiments. As shown, the system memory 316 stores the web browser 330 and an operating system 340 on which the web browser 330 runs. The operating system 340 may be, e.g., Linux® or Microsoft Windows® and includes a graphics driver 342 that implements a graphics API 332 exposed by the web browser 330 for rendering content, via the parallel processing subsystem 312 (and/or the CPU 302). For example, the graphics API 332 could be WebGL (Web Graphics Library), which is a JavaScript API for rendering interactive 3D and 2D graphics within a compatible web browser. In some embodiments, the data labeling application 104 may invoke the graphics API 332 to render 3D point clouds, and the data labeling application 104 may further provide tools that facilitate the labeling of data, according to techniques disclosed herein.

In alternate embodiments, the system 100 may include any number of client devices 102, any number of servers 130, any number of customer devices 110, any number of memories 304, and any number of processors 302 that are implemented in any technically feasible fashion. Further, the client devices 102, the servers 130, the memory 304, and the processor 302 may be implemented via any number of physical resources located in any number of physical locations. For example, the memory 304 and the processor 302 could be implemented in a cloud computing environment or a distributed computing environment that is accessible to the client device 102. The connection topology between the various units in FIGS. 1 and 2 may be modified as desired.

### Point Cloud Visualization

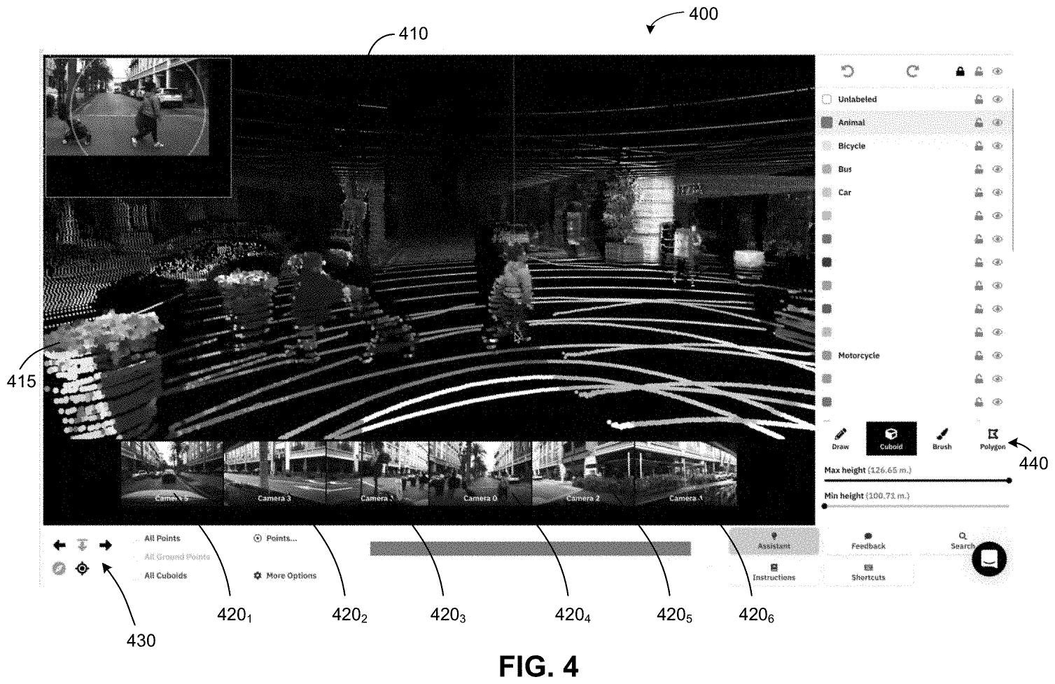

FIG. 4 illustrates an example user interface 400 displaying a point cloud, according to various embodiments. As shown, the UI 400, which is generated by the data labeling application 104, includes a rendering 410 of a 3D scene, photographs 420₁₋₆ associated with the rendered scene and captured at the same point in time, navigation controls 430, and labeling tools 440. As shown, the rendering 410 is a rendering of a 3D point cloud with colors derived from the photographs 420₁₋₆. For example, one or more LIDAR sensors (and/or radar systems) may be mounted on a vehicle to capture information about a 3D environment, and regular digital cameras may also be mounted on the vehicle to capture photographs from different vantage points. Known calibration information, such as the lengths of camera lenses, the positions of the cameras in world space, and the orientations and angles of the cameras, may be used to determine the locations at which points in the 3D world space would appear in the captured photographs, based on which colors may be derived for those points. Although an example of a point cloud coloring that is derived from the photographs 420₁₋₆ is shown for illustrate purposes, it should understood that the point coloring may generally be determined in any technically feasible manner, or no coloring may be applied at all. In some embodiments the default point cloud coloring may be no color, or a custom color (e.g., green for ground points). In addition, some embodiments may permit a user to select point cloud colorings based on the relative height of points.

Illustratively, the UI 400 includes navigation controls 430 that permit a user to rotate (e.g., by 90 degrees with each press of the left or right arrows, or to see a bird's eye view with a press on the downward arrow) the rendering 410, such that the point cloud can be viewed from different perspectives. The navigation controls 430 further permit the user to follow an object, such as a self-driving vehicle from which the photographs 420₁₋₆ and 3D point cloud data were captured, by pressing on the compass icon, or to follow a selection by pressing on the target icon. The user may also navigate freely within a 3D scene using, e.g., the w, a, s, and d keys on a keyboard or navigation controls provided via the UI 400, as well as zoom in and out using, e.g., a mouse scroll wheel or a trackpad. Further, the user interface 400 may also provide a visualization slider and shade points by depth, density, and local occlusion, which is a form of synthetic lighting that gives the points 3D structure that may help users to disambiguate what they see from different perspectives after the users move away from the origin. Otherwise, it may be unclear at other angles the orientation of points in 3D space, as some sides of objects may be occluded and not represented by points in the point cloud. For example, based on the depths of pixels in the rendering 410, the data labeling application 104 could perform a convolution for each pixel that takes the differences in depth of the pixel and its neighboring pixels, thereby distinguishing points that are closer to each other and further away, and adds a shading element to the pixel based on such differences. In addition, the UI 400 permits users to navigate through time to view renderings of frames associated with different points in time. This assumes that the data labeling application 104 receives 3D data (e.g., LIDAR data) as a series of point clouds, also referred to herein as a “video,” with each of the point clouds corresponding to a respective time stamp. For example, the 3D data could be a video at 5 Hz, which would include five frames per second, any of which the user may select to view. In some embodiments, the UI 400 may also permit a user to view point clouds from multiple frames simultaneously by superimposing the frames on top of each other, rather than requiring the user to step through the frames one by one. Doing so may help the user to visualize trajectories of objects (and assigned labels) over time

After navigating to a desired view (and time), the user may tag points as belonging to particular types of objects, draw annotations in the form of cuboids, or otherwise label data in the 3D scene using the labeling tools 440 provided by the data labeling application 104. Illustratively, the labeling tools 440 include a polygon tool, a draw tool, and a brush tool, that can be used to select points for labeling. The polygon and draw tools permit the user to draw polygons and arbitrary selection shapes, respectively, while the brush tool permits free-form labeling of points using a brush of a user-specified size. Further, the labeling tools 440 include a cuboid tool for selecting points within cuboids and adding cuboid annotations.

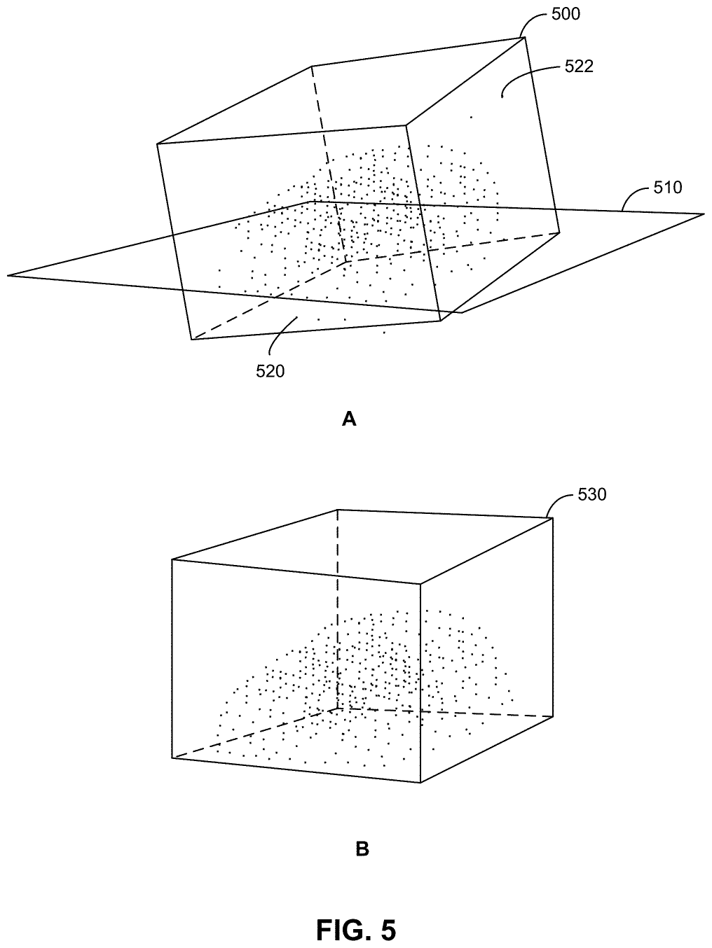

FIG. 5 illustrates an approach for automatically adjusting a user-drawn cuboid annotation, according to various embodiments. As shown in panel A, a user has drawn a cuboid annotation 500 around the points of a point cloud representing an object, which in this example is a vehicle. For example, the user could use the cuboid tool in the labeling tools 440 described above with respect to FIG. 4 to draw the cuboid annotation 500. In some embodiments, the data labeling application 104 may permit the user to add the cuboid annotation 500 using, e.g., a mouse click, and then change the dimensions of cuboid via hot keys or dragging with the mouse. The user may also be permitted to center the cuboid annotation 500 in the rendering of the point cloud, as well as to view the cuboid annotation 500 from different perspectives, such as from the side, front, and/or top, in order to facilitate making such adjustments to the dimensions of the cuboid annotation 500.

After drawing the cuboid annotation 500, the user may select for the data labeling application 104 to automatically adjust the hand-drawn cuboid 500. The data labeling application 104 may enable such an automatic adjustment to be selected in any technically feasible manner, such as via a hot key or by pressing a button presented on a UI. The goal of the automatic adjustment is to, given the cuboid annotation 500 as input, (1) determine which points should belong to the object bounded by the cuboid, as the user-drawn cuboid 500 may be over- and/or under-inclusive of such object points; and (2) fit a cuboid having the same dimensions as the user-drawn cuboid 500 to include the determined points that belong to the object.

In some embodiments, the data labeling application 104 may determine which points should belong to the object bounded by the cuboid by (1) removing from consideration points within the user-drawn cuboid 500 that are below a ground mesh 510 or that are statistical outliers, and (2) expanding into consideration points outside the user-drawn cuboid 500 based on a nearest-neighbor algorithm. The ground mesh 510 may be a pre-computed mesh that pervades the scene and gives, for each (x, y) coordinate, a corresponding z coordinate below which points belong to the ground and above which points belong to objects. Such a ground mesh 510 may be determined in any technically feasible manner. In some embodiments, the data labeling application 104 may compute the ground mesh 510 based on the point cloud and user input. For example, if the user draws cuboids around objects above what he or she perceives as being the ground, then the data labeling application 104 could fit the ground mesh 510 to align with the user-drawn cuboids. In such a case, points that are below the user-drawn cuboids in height could generally be considered to belong to the ground rather than objects, and vice versa. Thereafter, the data labeling application 104 may utilize the ground mesh 510 to remove from consideration points of the point cloud below the ground mesh, as such points are assumed to belong to the ground and not an object. Illustratively, the data labeling application 104 may remove a point 520, which is within the user-drawn cuboid 500 but below the ground mesh 510.

In conjunction with removing points that are below the ground mesh 510, the data labeling application 104 may also remove from consideration statistical outliers that differ significantly from other points within the user-drawn cuboid 500. In some embodiments, the data labeling application 104 may remove from consideration points that are in a predefined upper percentile of height (i.e., the z coordinate of the (x,y,z) coordinates defining the points). For example, the data labeling application 104 could partition the points into buckets based on their z coordinate values and, for each bucket, compute a variance of the x-y coordinates of points in the bucket. In such a case, the data labeling application 104 could remove from consideration outlier points based on the x-y variance in the corresponding buckets.

Such points are statistical outliers that may not belong to the object. Illustratively, the data labeling application 104 may remove a point 522, which is a statistical outlier in terms of height from the other points within the user-drawn cuboid 500.

Subsequent to removing points from consideration that are below the ground mesh 510 or that are statistical outliers, the data labeling application 104 expands into consideration some points outside the user-drawn cuboid 500 based on a nearest-neighbor algorithm. In some embodiments, the data labeling application 104 may crawl around the user-drawn cuboid 500 to determine additional neighboring points that should belong to the object. Such crawling may include determining the nearest neighbors of points within the user-drawn cuboid 500, up to a predefined distance threshold, and adding those points to the points belonging to the object. This point-crawling step, which may be repeated in some embodiments so long as there are points whose neighbors have not yet been explored, is akin to a graph-traversal algorithm adapted to 3D Euclidean space.

In some embodiments, the data labeling application 104 may first remove from consideration points belonging to the ground using a ground mesh, as described above. Ground points are typically dense (i.e., close together). As a result, the nearest neighbor algorithm may incorrectly identify ground points that are close to points in the cuboid 500 and add them to the set of object points if such ground points were not filtered out from consideration.

In some embodiments, the data labeling application 104 may also employ information other than how close neighboring points are to points within the user-drawn cuboid 500 to determine points outside the user-drawn cuboid 500 that should belong to the object within the cuboid 500. For example, the data labeling application 104 could determine, based on LIDAR intensity data, that certain points outside the user-drawn cuboid 500 have substantially the same intensity as points inside the cuboid 500. In various embodiments points having similar intensity levels indicate that those points represent the same material (which reflected LIDAR light with the same intensity back to the LIDAR sensor) as the points inside the cuboid 500. In such a case, the data labeling application 104 could expand the set of points considered to belong to the object to include the points outside the user-drawn cuboid 500 having substantially the same intensity as the points inside the user-drawn cuboid 500.

As shown in panel B, the data labeling application 104 fits a cuboid 530 having the same dimensions as the user-drawn cuboid 500 to include the points that are determined to belong to the object. Although discussed herein primarily with respect to the user-drawn cuboid 500 size being fixed, in some embodiments the data labeling application 104 may also adjust the dimensions of the user-drawn cuboid 500 to, e.g., fit the expanded set of points.

In some embodiments, the fitting is a maximization problem that optimizes a loss function defined based on (1) how tightly the adjusted cuboid bounds the points determined to belong to the object, and (2) how much the adjusted cuboid differs from the user-drawn cuboid 500. Further, the tightness may be determined based on distances between points representing faces of the object that are closest to the LIDAR sensor and corresponding faces of the adjusted cuboid. The faces closest to the LIDAR sensor may be determined using well-known techniques, and such faces are assumed to be the faces of the object that are not occluded from view of the LIDAR sensor. It should be understood that the opposing faces of the object, which are assumed to be occluded from view (as for every pair of faces, at most one should be occluded), may not be associated with any points in the point cloud. In such cases, it would not make sense to determine a fitting using such (non-existent) points. For example, at far away distances, LIDAR point clouds tend to be more sparse than at closer distances, and there may be no data for occluded faces of an object at such far away distances. Use of a loss function that determines tightness based on non-occluded faces accounts for such a lack of data for occluded faces.

In some embodiments, the data labeling application 104 may fix the dimension of the user-drawn cuboid 500 while trying a number of (e.g., a random or predefined number of) orientations and determining the position for each such orientation that optimizes the loss function described above. Then, given these candidate positions that optimize the loss function for various orientations, the data labeling application 104 may select the best fitting position and orientation (i.e., the position and orientation that provides the best overall optimization of the loss function).

Any technically feasible approach for fitting may be employed in other embodiments. For example, the data labeling application 104 may use up-sampling in some embodiments to inject synthetic points where faces of an object are occluded, and then fit the object points including the injected points.

In addition, the data labeling application 104 may permit a user to preview an automatically adjusted cuboid and either accept or reject the adjustment. For example, the data labeling application 104 could cause a UI to be displayed that shows the adjusted cuboid, which the user could opt in to or dismiss. If the user does not accept the automatically adjusted cuboid, the user may, e.g., manually adjust the cuboid or leave the user-drawn cuboid unadjusted.

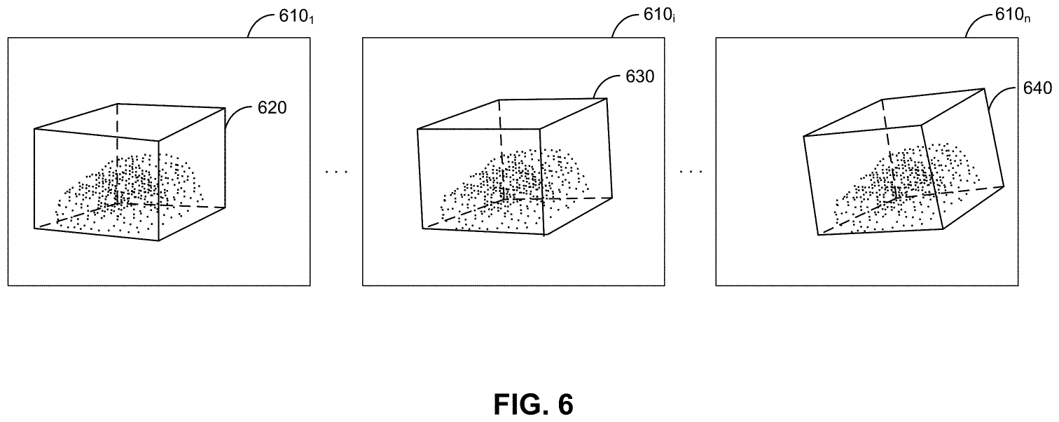

FIG. 6 illustrates an approach for propagating cuboid annotations across frames, according to various embodiments. As shown, a user has drawn cuboid annotations 620 and 640 and automatically adjusted the same in two key frames 610₁ and 610ₙ, respectively. In some embodiments, the data labeling application 104 may designate any frames that the user has edited as key frames and all other frames as in-between frames.

Illustratively, the data labeling application 104 automatically generates cuboids for in-between frames, such as the cuboid 630 generated for the in-between frame 610₁. In some embodiments, the data labeling application 104 may employ interpolation to generate cuboids for in-between frames by interpolating the cuboid annotations 620 and 640 in the key frames 610₁ and 610ₙ, respectively. In other embodiments, the data labeling application 104 may employ object tracking using RANSAC (Random Sample Consensus) to determine points belonging to the object in the in-between frames, and then generate cuboids based on such points and the cuboid annotations 620 and 640 in the key frames 610₁ and 610ₙ, respectively. In some embodiments object tracking may both interpolate within and extrapolate past an already-labeled frame range, in which case the extrapolation may be based on only one keyframe. For example, the extrapolation could use RANSAC and (optionally) the kinematic information from one labeled frame to generate cuboids for later frames.

In the case of interpolation, the data labeling application 104 may determine cuboids in frames between pairs of key frames by assuming the cuboid does not change speed or angular velocity between the key frames. The constant velocity and angular velocity of the cuboid between the pair of key frames may then be determined by dividing the position and angle difference of the cuboids in the key frames by the number of in-between frames. For example, if the object were traveling in a straight line, then the data labeling application 104 could perform linear interpolation. As another example, if the object were turning, then the data labeling application 104 could assume that the path of the object traces an arc of a circle. It should be understood that interpolation may help create a smooth path for the cuboid through the frames 610₁ -610ₙ.

In contrast to interpolation, which considers only the cuboids in key frames and not the point cloud itself, object tracking employs computer vision to look at the point cloud data, in addition to the positions of cuboids in the key frames. As a result, object tracking can account for acceleration. In some embodiments, the data labeling application 104 may implement object tracking using RANSAC to categorize which points belong to the object and which points do not. RANSAC is an algorithm that can be used to identify inliers and outliers, and the data labeling application 104 may consider the outliers to not belong to the object. Having determined which points belong to the object and which do not in a given in-between frame, the data labeling application 104 may then generate a cuboid (having the same size as the user-drawn cuboid in the keyframes) for that in-between frame that bounds the points belonging to the object in those frames. In some cases, RANSAC alone may be insufficient to fully determine the correct position and heading of a cuboid if, e.g., the points in an in-between frame are very sparse. In such cases, the data labeling application 104 may use the surrounding keyframes and cuboids therein as kinematics context. In particular, the tracking model used by the data labeling application 104 in some embodiments may prefer paths that are natural and smooth (i.e. velocity is aligned with heading, turns and acceleration are gradual), while avoiding jerky movement.

In some embodiments, the data labeling application 104 may also allow users to select between interpolation and object tracking. It should be understood that different techniques used to generate cuboids for in-between frames may have their own advantages and drawbacks. For example, the linear nature of interpolation could permit users to better predict the end result. Further, users may strategically pick key frames where velocity of the object is changing so that the velocity does not change in the in-between frames and interpolation works well. By contrast, the output of object tracking using RANSAC may be less predictable to users. However, such object tracking may be more accurate where the constant speed and angular velocity assumptions of interpolation do not hold true.

In addition, in some embodiments, the data labeling application 104 may permit users to select whether to accept the interpolated or tracked cuboids in the in-between frames. If the user does not accept interpolated or tracked cuboids, then the user may, e.g., create new key frames and draw the desired cuboid annotations therein.

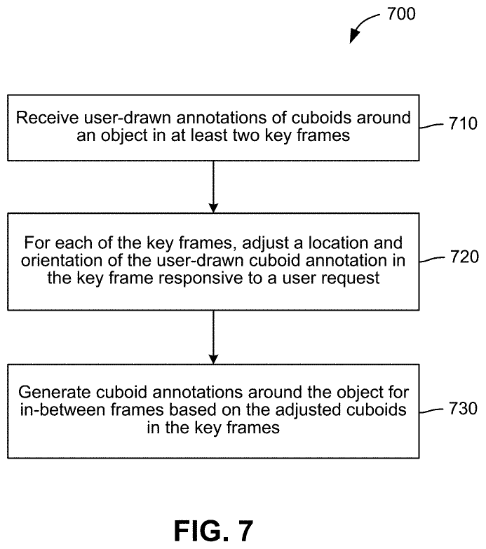

FIG. 7 is a flow diagram of method steps for automatically adjusting user-drawn cuboid annotations in key frames and propagating the cuboid annotations to in-between frames, according to various embodiments. Although the method steps are described with reference to the systems of FIGS. 1 and 3, persons skilled in the art will understand that any system may be configured to implement the method steps, in any order, in other embodiments.

As shown, a method 700 begins at step 710, where a data labeling application 104 receives user-drawn annotations of cuboids around an object in at least two key frames. The object could be, e.g., a vehicle or some other rigid object.

At step 720, for each of the key frames, the data labeling application 104 adjusts a position and orientation of the user-drawn cuboid annotation in the key frame responsive to a user request. In some embodiments, the user may press a button or hot key to activate the automatic adjustment of the user-drawn cuboid in the key frame. Although shown for illustrative purposes as being performed for each of the key frames, the data labeling application 104 may not adjust the user-drawn cuboid in some (or all of the) key frames if the user does not request such an adjustment. For example, the user could be satisfied with the cuboid annotation that he or she draws in some key frames and not press a button or hot key that activates the automatic adjustment for the user-drawn cuboid.

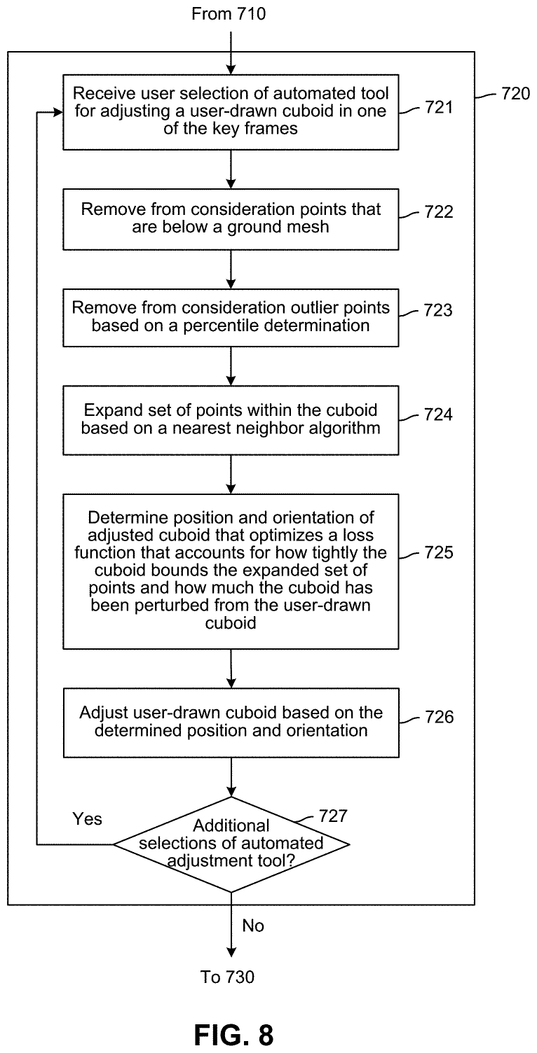

FIG. 8 illustrates the automatic adjustment of the position and orientation of the user-drawn cuboid annotations in response to user requests at step 720 in greater detail, according to various embodiments. As shown, at step 721, the data labeling application 104 receives a user selection of an automated tool for adjusting a user-drawn cuboid in a key frame. In some embodiments, the user may, while viewing a frame, draw a cuboid annotation and then press a button or hot key to select a tool for automatically adjusting the user-drawn cuboid in that frame. As described, the data labeling application 104 may also designate such a frame as a key frame, while other frames that the user has not edited may be designated as in-between frames.

At step 722, the data labeling application 104 removes from consideration points that are below a ground mesh. As described with respect to FIG. 5, the ground mesh is a mesh below which points are assumed to belong to the ground and not objects. The data labeling application 104 removes from consideration such points that belong to the ground rather than an object.

At step 723, the data labeling application 104 removes from consideration outlier points based on a percentile determination. In some embodiments, the data labeling application 104 may remove points that are in a predefined upper percentile of height, as described above with respect to FIG. 5.

At step 724, the data labeling application 104 expands the set of points within the cuboid based on a nearest neighbor algorithm. As described, the data labeling application 104 may crawl to neighboring points outside the user-drawn cuboid in some embodiments. In such cases, the data labeling application 104 may determine the nearest neighbors of points currently within the cuboid, up to a predefined distance threshold. The data labeling application 104 may then include such points as belonging to the object if the points are not too far from the user-drawn cuboid, and this process may be repeated several times in some embodiments.

In some embodiments, additional information other than how close neighboring points are to points within the user-drawn cuboid may be used to add points as belonging to the object. For example, in some embodiments, the data labeling application 104 may consider LIDAR intensity data to determine points that represent the same material and should belong to the same object

At step 725, the data labeling application 104 determines a position and orientation of a cuboid that optimizes a loss function that accounts for how tightly the cuboid bounds the expanded set of points and how much the cuboid has been perturbed from the user-drawn cuboid. As described, in some embodiments, the data labeling application 104 may try various orientations for the cuboid having the same dimensions and determine a position for each such orientation that optimizes the loss function. Thereafter, the data labeling application 104 may select the overall best fitting position and orientation that most optimizes the loss function. Further, in some embodiments, the loss function itself may determine tightness of a proposed cuboid's fit based on distances between points representing faces of the object that are closest to a LIDAR sensor, which are assumed to be non-occluded faces, and corresponding faces of the adjusted cuboid. It should be understood that the distances measured in such cases is the distance between the corresponding faces and the closest points, which represent the faces of the object, in the point cloud that are determined to belong to the object.

At step 726, the data labeling application 104 adjusts the user-drawn cuboid in the frame based on the position and orientation determined at step 725. At step 727, if the user makes additional selections of the automated adjustment tool for other frames in which the user draws cuboid annotations, then the method 700 returns to step 721. Otherwise, the method 700 proceeds to step 730.

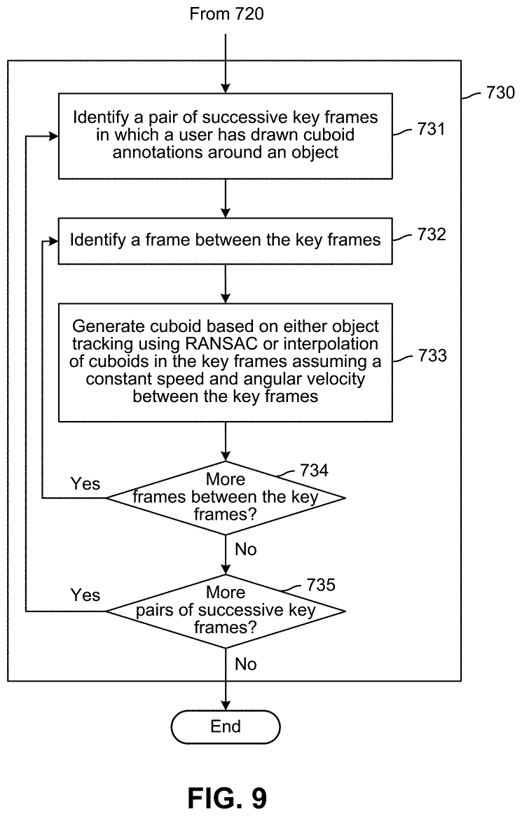

Returning to FIG. 7, at step 730, the data labeling application 104 generates cuboid annotations around the object in frames between the key frames based on the adjusted cuboids in the key frames. Doing so propagates the user-drawn and automatically adjusted cuboids in the key frames to frames that are between the key frames, so that the user is not required to draw cuboid annotations in such in-between frames. FIG. 9 illustrates the generating of cuboids for in-between frames at step 730 in greater detail, according to various embodiments. As shown, the data labeling application 104 iterates through pairs of successive key frames in which the user has drawn cuboid annotations around the object, identifying such a pair of successive key frames at step 731. For the identified pair of key frames, the data labeling application 104 further iterates through the frames between those key frames, identifying such frames as in-between frame at step 732. Although the pairs of successive key frames and in-between frames are shown as being processed sequentially for illustrative purposes, the data labeling application 104 may process successive key frames and/or in-between frames in parallel in alternative embodiments.

For one of the frames between the key frames, at step 733, the data labeling application 104 generates a cuboid around the object based on either object tracking using RANSAC (Random Sample Consensus) or an interpolation of cuboids in the key frames assuming a constant speed and angular velocity between the key frames. As described, interpolation determines cuboids in frames between pairs of key frames by assuming the cuboid does not change speed or angular velocity between the key frames. In contrast to interpolation, object tracking employs computer vision to look at the point cloud data, in addition to the positions of cuboids in the keyframes. As a result, object tracking can account for acceleration. In some embodiments, object tracking uses RANSAC to categorize which points belong to the object and which points do not in the in-between frames, and the data labeling application 104 generates cuboids around the points belonging to the object.

At step 734, if there are more frames between the key frames, then the method 700 returns to step 732, where the data labeling application 104 continues iterating through the frames between the key frames. On the other hand, if there are no more frames between the key frames, then the method 700 proceeds to step 735 where, if there are more pairs of successive key frames, then the method 700 returns to step 731, where the data labeling application 104 continues iterating through pairs of successive key frames. Otherwise, if there no more pairs of successive key frames, then the method 700 ends.

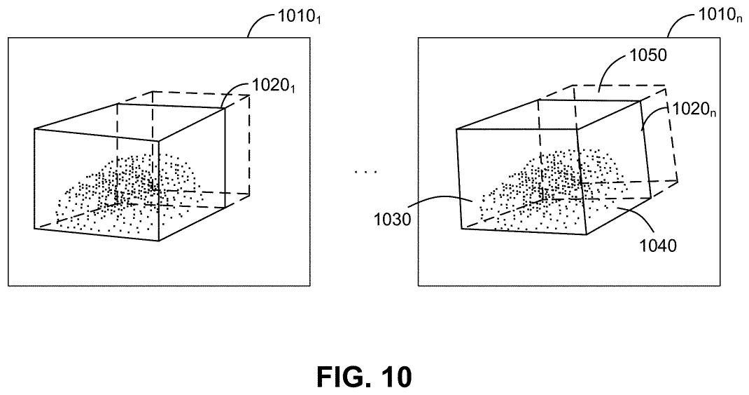

FIG. 10 illustrates an approach for propagating the re-sizing of a cuboid across frames, according to various embodiments. As shown, the user has re-sized a cuboid annotation 1020₁ bounding points that represent an object in one frame 1010₁. Although shown as the first frame for illustrative purposes, it should be understood that the user may generally resize the cuboid in any frame. For example, the user could determine that the dimensions of a previously drawn cuboid around a vehicle are incorrect after seeing the vehicle in additional frames. In such a case, the user could resize the cuboid in one of the frames to better match the size the vehicle. As the size of the vehicle is assumed to be fixed across all of the frames, the data labeling application 104 may automatically propagate the resized cuboid dimensions to other frames.

In response to the user resizing the cuboid annotation 1020₁ in the frame 1010₁, the data labeling application 104 automatically resizes the cuboid annotations in other frames. In some embodiments, the data labeling application 104 may resize the cuboid annotations in other frames (e.g., the cuboid annotation 1020ₙ in the frame 1010ₙ) as the user is re-sizing the cuboid annotation 1020₁ in the frame 1010₁, without requiring the user to press a button or hot key. For example, if the user wishes to add height to a cuboid, the user could drag his or her mouse to make the top face of the cuboid higher or the bottom face lower in one frame, and similarly for the other dimensions, and the data labeling application 104 may automatically propagate the user's resizing of the cuboid to other frames.

In some embodiments, during the automatic resizing of the cuboid annotations (in other frames), the data labeling application 104 fixes two of the non-occluded faces, which are closest to the LIDAR sensor, to their current planes. Doing so locks down, or “anchors,” those faces to the current planes. Whether the faces are closest to the LIDAR sensor may be determined based on, e.g., distances between centers of those faces and the LIDAR sensor. Illustratively, the closest faces 1030 and 1040 of the cuboid annotation 1020ₙ have been anchored in the frame 1010ₙ, while the planes of other faces, including the top face and the faces farther from the LIDAR sensor than the faces 1030 and 1040, are free to change (e.g., to move farther away or closer) in response to the resizing of the cuboid annotation 1020₁ in the frame 1010₁. For example, if the width of the cuboid annotation in one frame is changed from 10 to 12, then the data labeling application 104 could automatically propagate such a change in width to the cuboid annotations in other frames. Illustratively, the resizing of the cuboid annotation 1020₁ in the frame 1010₁ is propagated to the frame 1010ₙ by moving the occluded face 1050 backward while anchoring the faces 1030 and 1040.

Anchoring two of the non-occluded faces permits the data labeling application 104 to determine which faces to adjust. In particular, the data labeling application 104 adjusts the other faces, which may include the top and bottom faces and the side faces that are occluded, as it is assumed that the user has precisely positioned the cuboid annotation with respect to points representing the faces that are not occluded and that the user can see.

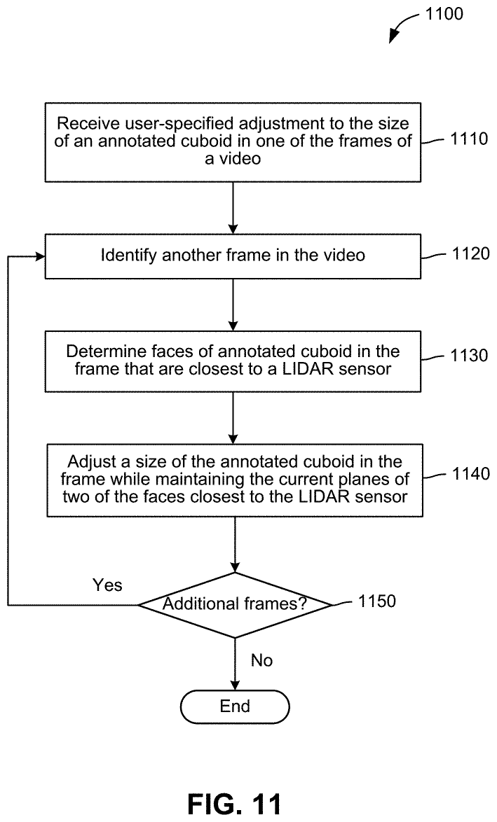

FIG. 11 is a flow diagram of method steps for adjusting the sizes of cuboid annotations in frames, according to various embodiments. Although the method steps are described with reference to the systems of FIGS. 1 and 3, persons skilled in the art will understand that any system may be configured to implement the method steps, in any order, in other embodiments.

As shown, a method 1100 begins at step 1110, where the data labeling application 104 receives a user-specified adjustment to the size of an annotated cuboid in one of the frames of a video. Such an adjustment may be made in any technically feasible manner, including via a hot key or dragging with a mouse, and the data labeling application 104 may further propagate the adjustment to other frames.

The data labeling application 104 then iterates through the other frames of the video, identifying one such other frame at step 1120. Although the other frames are shown as being processed sequentially for illustrative purposes, the data labeling application 104 may process such frames in parallel in alternative embodiments.

For the identified other frame in the video, at step 1130 the data labeling application 104 determines faces of the annotated cuboid in the frame that are closest to a LIDAR sensor. As described, at most one of two opposing faces of any object may be occluded from view and not associated with any points. The data labeling application 104 assumes that the face closest to the LIDAR sensor, which may be determined using well-known techniques, is not an occluded face.

At step 1140, the data labeling application 104 adjusts the size of the annotated cuboid in the frame while maintaining the current planes of two of the faces that are closest to the LIDAR sensor. As described, doing so essentially “anchors” those faces to their current planes, while allowing other faces to move (e.g., closer and/or farther away).

At step 1150, if there are additional frames in the video, then the method 1110 returns to step 1120, where the data labeling application 104 continues iterating through frames other than the frame that the user made an adjustment to.

Although discussed herein primarily with respect to vehicles, techniques disclosed herein may generally be applied to cuboid annotations of any rigid objects. In some embodiments, techniques disclosed herein may also be applied to non-rigid objects such as pedestrians and bicyclists. However, cuboids bounding pedestrians and other non-rigid objects are more complex than those of rigid objects, as non-rigid objects can contort their structure.

In sum, techniques are disclosed for facilitating the labeling of cuboid annotations in point cloud data. User-drawn annotations of cuboids in point cloud data can be automatically adjusted to remove outlier points, add relevant points, and fit the cuboids to points representative of an object. Interpolation and object tracking techniques are also disclosed for propagating cuboids from frames designated as key frames to other frames. In addition, techniques are disclosed for, in response to user adjustment of the size of a cuboid in one frame, automatically adjusting the sizes of cuboids in other frames while anchoring a set of non-occluded faces of the cuboids. The non-occluded faces may be determined as the faces that are closest to a LIDAR sensor in the other frames.

One advantage of the disclosed techniques is user-drawn annotations of cuboids in point cloud data can be automatically adjusted and improved upon. Techniques disclosed herein further propagate cuboids from key frames to in-between frames in a relatively smooth manner. In addition, size adjustments to cuboids are propagated while maintaining accuracy of the cuboid annotations, by anchoring a set of non-occluded faces of objects. These technical advantages represent one or more technological improvements over prior art approaches.

1. Some embodiments include a computer-implemented method for facilitating data labeling, the method comprising receiving a user-specified cuboid annotation associated with a first point cloud in a first frame, identifying one or more points in the first point cloud representing an object included in the first frame, and determining a first adjusted cuboid annotation based on a fit of the first adjusted cuboid annotation to the one or more points representing the object.

2. The computer-implemented method of clause 1, wherein determining the first adjusted cuboid annotation includes optimizing a loss function.

3. The computer-implemented method of any of clauses 1-2, wherein optimizing the loss function includes determining distances between points representing non-occluded faces of the object and corresponding faces of the first adjusted cuboid annotation.

4. The computer-implemented method of any of clauses 1-3, wherein the non-occluded faces of the object are determined based on distances between the non-occluded faces and a LIDAR (light detection and ranging) sensor.

5. The computer-implemented method of any of clauses 1-4, wherein optimizing the loss function further includes determining a difference between the first adjusted cuboid annotation and the user-specified cuboid annotation.

6. The computer-implemented method of any of clauses 1-5, wherein optimizing the loss function includes up-sampling the first point cloud.

7. The computer-implemented method of any of clauses 1-6, wherein identifying the one or more points representing the object comprises, identifying a set of points of the first point cloud that are within the user-specified cuboid annotation, removing, from the set of points, one or more points below a ground mesh separating points of the first point cloud that represent ground from points of the first point cloud that represent objects, removing, from the set of points, one or more outlier points above a predefined percentile of a height coordinate compared to other points of the first point cloud that are within the user-specified cuboid, and adding, to the set of points, one or more points of the first point cloud outside the user-specified cuboid annotation based on points of the first point cloud that are within the user-specified cuboid annotation and a nearest-neighbor technique.

8. The computer-implemented method of any of clauses 1-7, further comprising receiving a user-specified cuboid annotation associated with a second point cloud in a second frame, identifying one or more points in the second point cloud that represent the object, determining a second adjusted cuboid annotation based on a fit of the second adjusted cuboid annotation to the one or more points in the second point cloud representing the object, and determining a cuboid annotation associated with a third point cloud in a third frame based on the first and second adjusted cuboid annotations.

9. The computer-implemented method of any of clauses 1-8, wherein determining the cuboid annotation associated with the third point cloud includes interpolating the first and second adjusted cuboid annotations.

10. The computer-implemented method of any of clauses 1-9, wherein determining the cuboid annotation associated with the third point cloud further includes determining, using a computer vision technique, points representing the object in the third point cloud.

11. Some embodiments include a computer-readable storage medium including instructions that, when executed by a processing unit, cause the processing unit to perform operations for facilitating data labeling, the operations comprising receiving a user-specified cuboid annotation associated with a first point cloud in a first frame, identifying one or more points in the first point cloud representing an object included in the first frame, and determining a first adjusted cuboid annotation based on a fit of the first adjusted cuboid annotation to the one or more points representing the object.

12. The computer-readable storage medium of clause 11, wherein determining the first adjusted cuboid annotation includes optimizing a loss function.

13. The computer-readable storage medium of any of clauses 11-12, wherein optimizing the loss function includes determining distances between points representing non-occluded faces of the object and corresponding faces of the first adjusted cuboid annotation.

14. The computer-readable storage medium of any of clauses 11-13, wherein the non-occluded faces of the object are determined based on distances between the non-occluded faces and a LIDAR (light detection and ranging) sensor.

15. The computer-readable storage medium of any of clauses 11-14, wherein optimizing the loss function further includes determining a difference between the first adjusted cuboid annotation and the user-specified cuboid annotation.

16. The computer-readable storage medium of any of clauses 11-15, wherein identifying the one or more points representing the object comprises identifying a set of points of the first point cloud that are within the user-specified cuboid annotation, removing, from the set of points, one or more points below a ground mesh separating points of the first point cloud that represent ground from points of the first point cloud that represent objects, removing, from the set of points, one or more outlier points above a predefined percentile of a height coordinate compared to other points of the first point cloud that are within the user-specified cuboid, and adding, to the set of points, one or more points of the first point cloud outside the user-specified cuboid annotation based on points of the first point cloud that are within the user-specified cuboid annotation and a nearest-neighbor technique.

17. The computer-readable storage medium of any of clauses 11-16, the operations further comprising receiving a user-specified cuboid annotation associated with a second point cloud in a second frame, identifying one or more points in the second point cloud that represent the object, determining a second adjusted cuboid annotation based on a fit of the second adjusted cuboid annotation to the one or more points in the second point cloud representing the object, and determining a cuboid annotation associated with a third point cloud in a third frame based on the first and second adjusted cuboid annotations.

18. The computer-readable storage medium of any of clauses 11-17, wherein determining the cuboid annotation associated with the third point cloud includes either interpolating the first and second adjusted cuboid annotations or determining, using computer vision, points representing the object in the third point cloud.

19. Some embodiments include a computer-implemented method for propagating adjustments to a cuboid annotation size, the method comprising receiving a user-specified adjustment to a size of a first cuboid annotation in a first frame in a plurality of frames, identifying a second frame in the plurality of frames that includes a second cuboid annotation around an object, wherein a first set of faces of the object that are not occluded from view correspond to a second set of faces of the second cuboid annotation, and adjusting a size of the second cuboid annotation based on the user-specified adjustment to the size of the first cuboid annotation without modifying one or more planes associated with the second set of faces.

20. The computer-implemented method of clause 19, wherein the faces of the object that are not occluded are determined based on distances of faces of the object to a LIDAR (light detection and ranging) sensor.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

1. A computer-implemented method for facilitating data labeling, the method comprising:
receiving a user-specified cuboid annotation associated with a first point cloud in a first frame, wherein the user-specified cuboid annotation comprises a three-dimension cuboid annotation; and
subsequent to receiving the user-specified cuboid annotation, automatically:
identifying, based on the user-specified cuboid annotation, one or more points in the first point cloud representing an object included in the first frame, wherein the one or more points (i) include at least one point of the first point cloud that is outside the user-specified cuboid annotation, and/or (ii) do not include at least one point of the first point cloud that is within the user-specified cuboid annotation, and
determining a first adjusted cuboid annotation based on a fit of the first adjusted cuboid annotation to the one or more points representing the object.

2. The computer-implemented method of claim 1, wherein determining the first adjusted cuboid annotation includes optimizing a loss function.

3. The computer-implemented method of claim 2, wherein optimizing the loss function includes determining distances between points representing non-occluded faces of the object and corresponding faces of the first adjusted cuboid annotation.

4. The computer-implemented method of claim 3, wherein the non-occluded faces of the object are determined based on distances between the non-occluded faces and a LIDAR (light detection and ranging) sensor.

5. The computer-implemented method of claim 3, wherein optimizing the loss function further includes determining a difference between the first adjusted cuboid annotation and the user-specified cuboid annotation.

6. The computer-implemented method of claim 2, wherein optimizing the loss function includes up-sampling the first point cloud.

7. The computer-implemented method of claim 1, wherein identifying the one or more points representing the object comprises:
identifying a set of points of the first point cloud that are within the user-specified cuboid annotation;
removing, from the set of points, one or more points below a ground mesh separating points of the first point cloud that represent ground from points of the first point cloud that represent objects;
removing, from the set of points, one or more outlier points above a predefined percentile of a height coordinate compared to other points of the first point cloud that are within the user-specified cuboid; and
adding, to the set of points, one or more points of the first point cloud outside the user-specified cuboid annotation based on points of the first point cloud that are within the user-specified cuboid annotation and a nearest-neighbor technique.

8. The computer-implemented method of claim 1, further comprising:
receiving a user-specified cuboid annotation associated with a second point cloud in a second frame;
identifying one or more points in the second point cloud that represent the object;
determining a second adjusted cuboid annotation based on a fit of the second adjusted cuboid annotation to the one or more points in the second point cloud representing the object; and
determining a cuboid annotation associated with a third point cloud in a third frame based on the first and second adjusted cuboid annotations.

9. The computer-implemented method of claim 8, wherein determining the cuboid annotation associated with the third point cloud includes interpolating the first and second adjusted cuboid annotations.

10. The computer-implemented method of claim 8, wherein determining the cuboid annotation associated with the third point cloud further includes determining, using a computer vision technique, points representing the object in the third point cloud.

11. A non-transitory computer-readable storage medium including instructions that, when executed by a processing unit, cause the processing unit to perform operations for facilitating data labeling, the operations comprising:
receiving a user-specified cuboid annotation associated with a first point cloud in a first frame, wherein the user-specified cuboid annotation comprises a three-dimension cuboid annotation; and
subsequent to receiving the user-specified cuboid annotation, automatically:
identifying, based on the user-specified cuboid annotation, one or more points in the first point cloud representing an object included in the first frame, wherein the one or more points (i) include at least one point of the first point cloud that is outside the user-specified cuboid annotation, and/or (ii) do not include at least one point of the first point cloud that is within the user-specified cuboid annotation, and
determining a first adjusted cuboid annotation based on a fit of the first adjusted cuboid annotation to the one or more points representing the object.

12. The computer-readable storage medium of claim 11, wherein determining the first adjusted cuboid annotation includes optimizing a loss function.

13. The computer-readable storage medium of claim 12, wherein optimizing the loss function includes determining distances between points representing non-occluded faces of the object and corresponding faces of the first adjusted cuboid annotation.

14. The computer-readable storage medium of claim 13, wherein the non-occluded faces of the object are determined based on distances between the non-occluded faces and a LIDAR (light detection and ranging) sensor.

15. The computer-readable storage medium of claim 13, wherein optimizing the loss function further includes determining a difference between the first adjusted cuboid annotation and the user-specified cuboid annotation.

16. The computer-readable storage medium of claim 11, wherein identifying the one or more points representing the object comprises:
identifying a set of points of the first point cloud that are within the user-specified cuboid annotation;
removing, from the set of points, one or more points below a ground mesh separating points of the first point cloud that represent ground from points of the first point cloud that represent objects;
removing, from the set of points, one or more outlier points above a predefined percentile of a height coordinate compared to other points of the first point cloud that are within the user-specified cuboid; and
adding, to the set of points, one or more points of the first point cloud outside the user-specified cuboid annotation based on points of the first point cloud that are within the user-specified cuboid annotation and a nearest-neighbor technique.

17. The computer-readable storage medium of claim 11, the operations further comprising:
receiving a user-specified cuboid annotation associated with a second point cloud in a second frame;
identifying one or more points in the second point cloud that represent the object;
determining a second adjusted cuboid annotation based on a fit of the second adjusted cuboid annotation to the one or more points in the second point cloud representing the object; and
determining a cuboid annotation associated with a third point cloud in a third frame based on the first and second adjusted cuboid annotations.

18. The computer-readable storage medium of claim 17, wherein determining the cuboid annotation associated with the third point cloud includes either interpolating the first and second adjusted cuboid annotations or determining, using computer vision, points representing the object in the third point cloud.

19. A computer-implemented method for propagating adjustments to a cuboid annotation size, the method comprising:
receiving a user-specified first cuboid annotation around an object in a first point cloud in a first frame of a plurality of frames;
generating, based on the first cuboid annotation, a second cuboid annotation around the object in a second point cloud in a second frame of the plurality of frames, wherein a first set of faces of the object that are not occluded from view correspond to a second set of faces of the second cuboid annotation;
subsequent to generating the second cuboid annotation, receiving a user-specified adjustment to a size of the first cuboid annotation in the first frame; and
automatically adjusting a size of the second cuboid annotation included in the second frame based on the user-specified adjustment to the size of the first cuboid annotation included in the first frame without modifying one or more planes associated with the second set of faces.

20. The computer-implemented method of claim 19, wherein the faces of the object that are not occluded are determined based on distances of faces of the object to a LIDAR (light detection and ranging) sensor.
